(19) United States
(12) Patent Application Publication
(10) Pub. No.: US 2023/0363464 A1
(43) Pub. Date: Nov. 16, 2023

(54) AEROSOL PROVISION DEVICE

(71) Applicant: Nicoventures Trading Limited, LONDON (GB)

(72) Inventors: Daniel LOCHTMAN, London (GB); David BUREAU, London (GB); James SHERIDAN, London (GB)

(21) Appl. No.: 18/248,320

(22) PCT Filed: Oct. 15, 2021
(86) PCT No.: PCT/EP2021/078688

§ 371 Date: Apr. 7, 2023

(30) Foreign Application Priority Data
Oct. 16, 2020 (GB) 2016479.4

(51) Int. Cl. A24F 40/51; A24F 40/20; A24F 40/465; A24F 40/48; H05B 6/10

(52) U.S. Cl. CPC A24F 40/51; A24F 40/20; A24F 40/465; A24F 40/48; H05B 6/105

(57) ABSTRACT

An aerosol provision device includes an induction coil for generating a varying magnetic field, and a heater assembly having a heating chamber for receiving at least a portion of an article having aerosolizable material, a base, and a heating element heatable by the induction coil, the heating element protruding into the heating chamber from the base and defining an axis (A), and a temperature sensor for sensing a temperature of the heating element, wherein the temperature sensor is positioned in contact with the heating element in the base of the heater assembly and separated from the heating chamber.

### PRIORITY CLAIM

The present application is a National Phase entry of PCT Application No. PCT/EP2021/078688, filed Oct. 15, 2021, which claims priority from GB Application No. 2016479.4, filed Oct. 16, 2020, each of which is hereby fully incorporated herein by reference.

### TECHNICAL FIELD

The present invention relates to an aerosol provision device. The present invention also relates to an aerosol provision device heater assembly, methods of forming the same, and an aerosol provision system comprising the aerosol provision device and an article comprising aerosol generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect of the present disclosure, there is provided an aerosol provision device comprising an induction coil for generating a varying magnetic field, and a heater assembly having a heating chamber for receiving at least a portion of an article comprising aerosolisable material, a base, a heating element heatable by the induction coil, the heating element protruding into the heating chamber from the base and defining an axis, and a temperature sensor for sensing a temperature of the heating element, wherein the temperature sensor is positioned in thermal contact with the heating element in the base of the heater assembly and separated from the heating chamber.

In an embodiment of the above, the thermal sensor is a thermocouple.

In a further embodiment of any of the above, the aerosol provision device comprises a sensor channel in the base, the sensor channel receiving the thermal sensor.

In a further embodiment of any of the above, the sensor channel is separated from the heating chamber.

In a further embodiment of any of the above, the sensor channel is fluidly isolated from the heating chamber.

In a further embodiment of any of the above, the sensor channel is radially offset from the axis of the heating element.

In a further embodiment of any of the above, the sensor channel extends radially into the base from an outer surface of the heater assembly.

In a further embodiment of any of the above, the sensor channel extends axially into the base from an outer surface of the heater assembly.

In a further embodiment of any of the above, the aerosol provision device comprises an air passage in the base in communication with the heating chamber.

In a further embodiment of any of the above, the sensor channel is separated from the air passage.

In a further embodiment of any of the above, the sensor channel is fluidly isolated from the air passage.

In a further embodiment of any of the above, an axis of the air passage is offset from the axis of the heating element.

In a further embodiment of any of the above, the air passage is a single air passage extending through the base.

In a further embodiment of any of the above, the heating element comprises an anchoring portion in the base, the sensor channel intersecting with the anchoring portion.

In a further embodiment of any of the above, the temperature sensor is in thermal contact with the anchoring portion of the susceptor.

In a further embodiment of any of the above, the aerosol provision device comprises a device air passage extending from an opening in a distal end of the device housing and to the heater assembly.

In a further embodiment of any of the above, the at least one inductive coil comprises two inductive coils which are separatelyenergizable.

In a further embodiment of any of the above, the heater assembly is removably secured in the device housing.

According to an aspect of the present disclosure, there is provided a system comprising the aerosol provision device of any of the above, and a removable article received within the heater assembly of the device.

According to an aspect of the present disclosure, there is provided a heater assembly for an aerosol provision device, the heater assembly comprising a heating chamber for receiving at least a portion of an article comprising aerosolisable material, a base, a heating element that protrudes into the heating chamber from the base and defines an axis, the heating element being configured to heat a portion of the article received in the heating in response to penetration by a varying magnetic field generated by an induction coil, and a temperature sensor for sensing a temperature of the heating element, wherein the temperature sensor is in thermal contact with the heating element and separated from the heating chamber.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 shows an aerosol provision device according to one embodiment;

FIG. 2 shows a sectional view of the aerosol provision device of FIG. 1;

FIG. 3 shows an embodiment of a heating assembly; and

FIG. 4 shows another embodiment of a heating assembly.

### DETAILED DESCRIPTION

As used herein, the term “aerosol generating material” includes materials that provide volatilized components upon heating, typically in the form of an aerosol. Aerosol generating material includes any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

Apparatus is known that heats aerosol generating material to volatilize at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus.

An aerosol provision device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

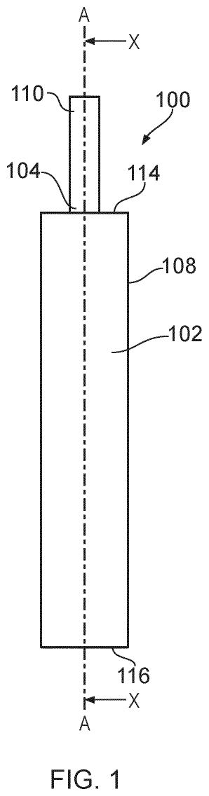

FIG. 1 shows an example of an aerosol provision device 100 for generating aerosol from an aerosol generating medium/material. In broad outline, the device 100 may be used to heat a replaceable article 110 comprising the aerosol generating medium, to generate an aerosol or other inhalable medium which is inhaled by a user of the device 100.

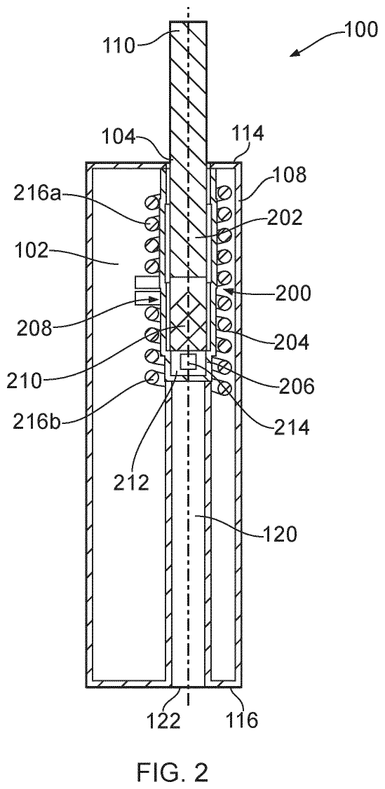

The device 100 comprises a housing 102 (including an outer cover 108) which surrounds and houses various components of the device 100. The device 100 has an opening 104 in one end, through which the article 110 may be inserted for heating by a heater assembly 200 (refer to FIG. 2). In use, the article 110 may be fully or partially inserted into the heater assembly 200 where it may be heated by one or more components of the heater assembly 200.

The device 100 may also include a user-operable control element (not shown), such as a button or switch, which operates the device 100 when pressed. For example, a user may turn on the device 100 by operating the switch.

The device 100 may also comprise an electrical component, such as a connector/port (not shown), which can receive a cable to charge a battery of the device 100. For example, the connector may be a charging port, such as a USB charging port. In some examples the connector may be used additionally or alternatively to transfer data between the device 100 and another device, such as a computing device.

The device comprises a power source (not shown), for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The device 100 defines a proximal end 114, which is generally the end from which the user may inhale the aerosol which is generated, and a distal end 116 which is at an opposite end of the device to the proximal end 114. The device further defines an axis A defined by a heating element (see FIG. 2) which extends from the proximal end 114 to the distal end 116.

FIG. 2 shows a sectional view of the aerosol provision device of FIG. 1, taken along the line X, which shows the arrangement of the heater assembly 200 in more detail.

The heater assembly 200 comprises a heating chamber 202 into which the replaceable article 110 is inserted through the opening 104 in the device 100. The heating chamber 202 is defined by a chamber wall 204 which extends from the opening 104 at the proximal end 114 in an axial direction partway towards the distal end 116. In the example shown, the chamber wall 204 is annular about the axis A, and defines a generally cylindrical shape for the chamber 202.

The heater assembly 200 comprises a base 206, which bounds the heating chamber 202 at a distal, or lower, axial end of the chamber 202 and the wall 204. The base 206 comprises a section of generally solid material, with openings formed therein, as will be described in more detail below. The base 206 is connected to the chamber wall 204. In the example shown, the base 206 and the chamber wall 204 are integrally formed.

The heater assembly 200 may be connected to the device 100, or integrally formed therewith. Alternatively, the heater assembly 200 may be removable from and insertable into the device via the opening 104, and be secured to the device 100 by any known removable means. In pictured examples, the heater assembly comprises protrusions which are received by correspondingly-shaped recesses in the device.

The device 100 may comprise an air passage 120 which extends from an opening 122 in a distal end of the device and to the heater assembly 200, to provide air to the heater assembly 200.

The base 206 further comprises a receiving slot 214, which extends axially in a distal direction from a surface of the base 206 which bounds the heating chamber 202. In the example shown, the receiving slot 214 comprises a generally rectangular cross-section in the direction of the axis A. In the example shown, the receiving slot is centered relative to the base 206. That is, the base 206 comprises a center point in the radial plane, defined as a center of the cross section of the heating chamber 202.

The receiving slot 214 has a smaller cross-sectional area than a cross-sectional area of the heating chamber 202, such that a correspondingly shaped component can be received therein (as described below).

The heater assembly 200 further comprises a heating element, or susceptor 208 partially disposed in the chamber 202 and in the base 206. The susceptor 208 defines an axis X in the direction of extension into the chamber 202 in a direction from the distal to the proximal end of the device 100. The susceptor 208 comprises a blade 210, or heating portion, and an anchoring portion 212. The anchoring portion 212 is received in the receiving slot 214 and secured therein, for example in a sliding interference fit, to hold the susceptor 208 in place relative to the base 206. The anchoring portion 212 is entirely received in the receiving slot 214, and the blade 210 extends axially outwards into the heating chamber 202 in a proximal direction from the anchoring portion 212 and from the base 206 to which the susceptor 208 is secured. At least a portion of the susceptor 208 comprises a ferromagnetic material such as iron, nickel or cobalt, so as to be heated by induction, as described further below.

In another embodiment, the susceptor 208 is integrally formed with the base 206, such that the anchoring portion 212 is embedded within the mount. This arrangement may be formed, for example, by injection molding of the heater assembly 200.

The blade 210 is disposed within the heating chamber 202. In the example shown, the blade 210 is separated from and does not contact the chamber wall 204. In the example shown, the blade 210 is generally centered on the base 206 and in the chamber 202. When the replaceable article 110 is received into the device 100 through the opening 104 and into the chamber 202, it can be inserted until it abuts with the base 206. The blade 210 or heating portion of the susceptor 208, extending from the base 206, therefore enters the replaceable article 110 when it is inserted. The susceptor 208 may therefore heat the replaceable article 110 from within, as described further below.

In the example shown, the blade 210 comprises a flat blade shape, with two opposed surfaces separated by edges, the edges tapering towards a point. The flat surfaces provide improved heat distribution, while the edges and point allow the removable article 110 to be easily pierced on insertion into the heating chamber 202. In alternative example which are not shown, the susceptor may comprise other shapes, for example a pin or a rod shape.

The device 100 further comprises an induction coil or coils 216. The coils extend helically around the chamber walls 204 along a part of the axial length of the heater assembly 200, so as to surround the heating chamber 202 and the base 206.

The coils 216 are connected to a power source. The user may control the device 100, for example by the user-operable control element 112, to cause the power source to energize the coils 216. The coils 216 are energized with an alternating current, which produces a varying magnetic flux in the heating chamber 202. The varying magnetic flux causes an electrical current to be generated in the ferromagnetic material in the susceptor 208 and the blade 210. The electrical current causes the blade 210 to heat, which in turn heats the replaceable article 110 from the inside, and causes an aerosol to be generated, which can be inhaled by the user.

In the example shown, there are two induction coils 216a, 216b, which are configured to be separately energized to provide different levels of magnetic flux and subsequently different levels of heating. In the example shown, each of the two coils 216 extends along about half of the axial length of the chamber 202.

The induction coil or coils 216a, 216b are made from an electrically conducting material. In this example, the induction coils 216a, 216b are made from Litz wire/cable which is wound in a helical fashion to provide a helical coil. Litz wire comprises a plurality of individual wires which are individually insulated and are twisted together to form a single wire. Litz wires are designed to reduce the skin effect losses in a conductor. In the example device 100, the inductor coil 124 is made from copper Litz wire which has a circular cross section. In other examples the Litz wire can have other shape cross sections, such as rectangular.

In addition to the susceptor 208 which extends into the heating chamber 202, the device may comprise further additional susceptors. The additional susceptor or susceptors may be of differing or similar configurations (e.g. pin-shaped, blade-shaped or receptacle-type etc.), as required.

As described above, it is desirable to volatilize an aerosol generating material in the replaceable article 110 with little to no burning or combusting of the material. To that end, it is desirable to accurately control the temperature to which the susceptor 208 is heated, in order to control the temperature which is applied to the replaceable article 110.

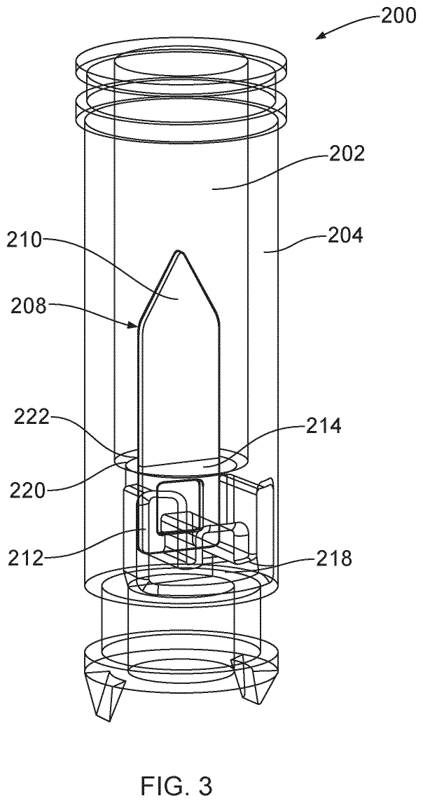

FIG. 3 shows a view of one embodiment of the heater assembly 200 in more detail. As described above, the anchoring portion 212 of the susceptor 208 is received into the receiving slot 214 formed in the base 206. The base 206 further comprises a sensor channel 218 formed therein.

The sensor channel 218 extends from a radially outer surface 220 of the base 206. The sensor channel 218 extends radially inwards into the base 206 and intersects with the anchoring portion 212 of the susceptor 208, so as to expose the anchoring portion 212 to the sensor channel 218. Where the anchoring portion 212 is received in a receiving slot 214, the receiving slot 214 is intersected by the sensor channel. By this arrangement, the anchoring portion 212 of the susceptor 208 is accessible through the sensor channel 218. A thermal sensor (not shown) is disposed in the sensor channel 218, and is in thermal contact with the susceptor 206. In some examples, the thermal contact may comprise a direct contact between the thermal sensor and a part of the susceptor 206, i.e. a portion of the thermal sensor touches a portion of the susceptor directly. In the example shown, the thermal sensor is in direct contact with the anchoring portion 212 of the susceptor 208.

In the example shown, the sensor channel 218 extends from an opening 224 in an outer surface of the heater assembly 200, so that the thermal sensor may be inserted or removed from the sensor channel, and so that a wired connection may be provided between the thermal sensor and the controller to provide accurate and precise measurement of temperature.

The thermal sensor is a thermocouple, which is particularly effective for measuring the temperature of the susceptor 208, especially when in direct contact therewith. In the example shown, the sensor channel 218 comprises a generally ‘W’ shaped cross-section in the radial direction in which it extends, so as to accommodate a thermocouple-type sensor in a reduced volume of the base 206.

In use, the thermal sensor measures, monitors or otherwise detects the temperature of the susceptor 208. The thermal sensor is in communication with a controller (not shown) of the device 100, and provides temperature data to the controller. The controller can control the energization of the coils 216, which in turn controls the temperature. The controller can be of any known type, for example a PID controller.

It has been found that the replaceable article 110, when heated, produces a residue byproduct which can accumulate in the heating chamber 202. It has further been found that the residue byproduct can have particularly undesirable effects on sensitive components such as the thermal sensor, and the function of the thermal sensor can be compromised by the accumulation of residue byproduct in the chamber 202.

In order to reduce the sensitivity to residue byproduct in the chamber 202, the sensor channel 218 is separated from the cavity by being formed in the base 206. The sensor channel 218 is fluidly isolated from the heating chamber 202. The residue which may accumulate in the heating chamber 202 is therefore significantly separated from the thermal sensor, and the effect of residue on the thermal sensor is reduced.

In addition, the placement of the sensor channel 218 in the base 206 of the heater assembly 200 allows the thermal sensor to be placed adjacent to the susceptor 208 despite the susceptor being disposed towards a center of the heating chamber 202 and separated from the walls 204. This positioning allows a more accurate and precise temperature reading to be taken by the thermal sensor. The sensor channel 218 is radially offset from the susceptor 208 so that the anchoring portion 212 and the thermal sensor can both be accommodated.

In certain embodiments, such as the one shown, the heater assembly 200 is provided with an air passage 220 which provides air to the heating chamber 202 at a location generally adjacent to the base 204. In the example shown, the air passage 220 extends axially through the base 204 of the heater assembly 200 to an opening 222 into the heating chamber 202. The air passage 220 and heating chamber 202 together define an air flow path through the device.

In the example shown, the opening 222 is radially separated from the susceptor 208, such that the base 206 comprises a region of solid material between the air passage 220 and the receiving slot 214. The separation provides the receiving slot 214 with a structural integrity to hold the susceptor 208 securely in place.

It has been found that, where an air passage 220 is provided, residue byproduct, or similarly-undesirable condensate byproduct, can enter air passage 220, and affect components which are exposed therein. For this reason, it can be desirable to separate the sensor channel 218 from the air passage 220 in addition to separating the channel 218 from the heating chamber 202. The sensor channel 218 is therefore fluidly isolated from the air passage 220. Through this arrangement, the sensor channel 218 is further protected from possible effects of residue.

In the embodiment shown, the air passage 220 is provided through the base 206 in an off-center position. That is, the base 206 defines a center point, and the opening 222 of the air passage 220 is radially separated from the center point. The air passage 220 is on a radially opposed side of the center point to the sensor channel 218. That is, the base 206 defines two notional halves separated in the radial direction, one half comprising the air passage 220 and the other half comprising the sensor channel 218.

The off-center positioning of the air passage allows the sensor channel 218 to be provided on an opposed side of the base 206 as described while being separated therefrom. Through this arrangement, both air passage 220 and thermal sensor may be provided in the base 206 while remaining separated. The solid region of material of the base 206 which lies between the air passage 220 and the sensor channel 218 effectively provides a barrier between the air passage 220 and the thermal sensor.

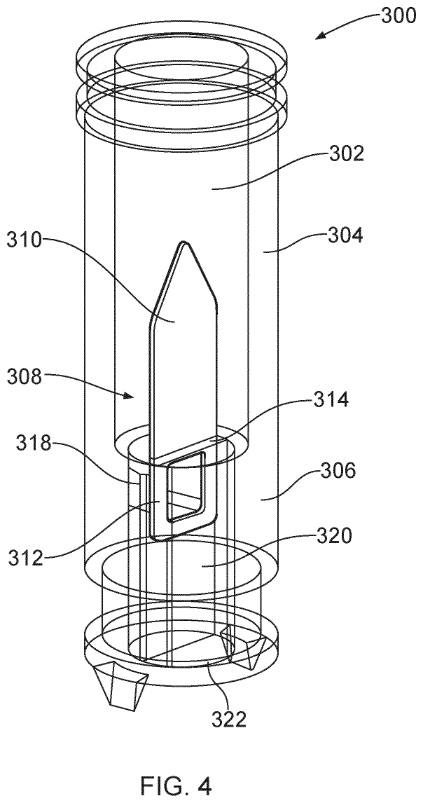

FIG. 4 shows a further embodiment of a heater assembly 300 for use with the device 100. The embodiment is generally the same as that described in relation to FIGS. 1, 2 and 3, comprising a heating chamber 302 with a base 306 and a susceptor 308 extending from the base 306.

In this embodiment, a sensor channel 318 is provided which extends axially through the base 306, instead of the radially-extending channel described in relation to the previous embodiment. The sensor channel 318 receives a thermal sensor for sensing a temperature of the susceptor 308, as described above. The sensor channel 318 comprises an opening 324 at an outer, bottom (or distal) end of the heater assembly 300. The sensor channel 318 extends axially in an upwards, or proximal, direction, from the opening 324, and ends at a location axially separated from the heating chamber 302. As such, a region of material of the base 304 separates the sensor channel 318 from the heating chamber 302, and the sensor channel 318 is fluidly isolated from the heating chamber 302.

As described in relation to the previous embodiment, the channel is open to the exterior of the heater assembly 300 so that the thermal sensor may be inserted or removed from the sensor channel, and a wired connection may be provided between the thermal sensor and the controller to provide accurate and precise measurement of temperature.

In the embodiment shown, the sensor channel 318 intersects with the anchoring portion 312 of the susceptor 308, so as to expose the anchoring portion 312 to the sensor channel 318. Where the anchoring portion 212 is received in a receiving slot 214, the receiving slot 214 is intersected by the sensor channel. By this arrangement, the anchoring portion 312 of the susceptor 308 is accessible through the sensor channel 318. A thermal sensor (not shown) is disposed in the sensor channel 218, and is in thermal contact with the susceptor 206. In the example shown, the thermal sensor is in direct contact with the anchoring portion 212 of the susceptor 208. The thermal sensor may therefore be in thermal contact with the anchoring portion 312 to measure the temperature of the susceptor accurately and precisely, as described above.

In one example, the susceptor 206 may comprise an anchoring portion 212 which is generally L-shaped. The L-shaped anchoring portion comprises an axial section extending from the blade 208, and a radial section extending from an opposed end of the axial section. The thermal sensor may be attached and in thermal contact with the radial section, for example by soldering. Providing an L-shaped anchoring portion with a radial section may allow the thermal sensor to be connected to the anchoring portion in a robust, compact manner which is easy to assemble.

An axially-extending air passage 320 is provided in an off-center position, as described above. The sensor channel 318 is also position off-center in the base 306, in an opposed radial direction to air passage 320, such that both sensor channel 318 and air passage 320 may be provided in the base 306 while separating and fluidly isolating the thermal sensor from the air passage 320.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

A detailed listing of all claims that are, or were, in the present application, irrespective of whether the claim(s) remain(s) under examination in the application is presented below. The claims are presented in ascending order and each includes one status identifier. Those claims not cancelled or withdrawn but amended by the current amendment utilize the following notations for amendment: 1. deleted matter is shown by strikethrough for six or more characters and double brackets for five or fewer characters; and 2. added matter is shown by underlining.

1. An aerosol provision device comprising:
an induction coil for generating a varying magnetic field; and
a heater assembly having:
a heating chamber for receiving at least a portion of an article comprising aerosolizable material;
a base;
a heating element heatable by the induction coil, the heating element protruding into the heating chamber from the base and defining an axis; and
a temperature sensor for sensing a temperature of the heating element, wherein
the temperature sensor is positioned in thermal contact with the heating element in the base of the heater assembly and separated from the heating chamber.

2. The aerosol provision device of claim 1, wherein the thermal sensor is a thermocouple.

3. The aerosol provision device of claim 1 or 2, comprising a sensor channel in the base, the sensor channel receiving the thermal sensor.

4. The aerosol provision device of claim 3, wherein the sensor channel is separated from the heating chamber.

5. The aerosol provision device of claim 4, wherein the sensor channel is fluidly isolated from the heating chamber.

6. The aerosol provision device of claim 3, wherein the sensor channel is radially offset from the axis of the heating element.

7. The aerosol provision device of claim 3, wherein the sensor channel extends radially into the base from an outer surface of the heater assembly.

8. The aerosol provision device of claim 3, wherein the sensor channel extends axially into the base from an outer surface of the heater assembly.

9. The aerosol provision device of claim 1, comprising an air passage in the base in communication with the heating chamber.

10. The aerosol provision device of claim 9, wherein the sensor channel is separated from the air passage.

11. The aerosol provision device of claim 10, wherein the sensor channel is fluidly isolated from the air passage.

12. The aerosol provision device of claim 9, wherein an axis of the air passage is offset from the axis of the heating element.

13. The aerosol provision device of claim 9, wherein the air passage is a single air passage extending through the base.

14. The aerosol provision device of claim 1, wherein the heating element comprises an anchoring portion in the base, the sensor channel intersecting with the anchoring portion.

15. The aerosol provision device of claim 14, wherein the temperature sensor is in thermal contact with the anchoring portion of the susceptor.

16. The aerosol provision device of claim 1, further comprising a device air passage extending from an opening in a distal end of the device housing and to the heater assembly.

17. The aerosol provision device of claim 1, wherein the at least one inductive coil comprises two inductive coils which are separately energizable.

18. The aerosol provision device of claim 1, wherein the heater assembly is removably secured in the device housing.

19. A system comprising:
the aerosol provision device of claim 1; and
a removable article received within the heater assembly of the device.

20. A heater assembly for an aerosol provision device, the heater assembly comprising:
a heating chamber for receiving at least a portion of an article comprising aerosolizable material;
a base;
a heating element that protrudes into the heating chamber from the base and defines an axis, the heating element being configured to heat a portion of the article received in the heating in response to penetration by a varying magnetic field generated by an induction coil; and
a temperature sensor for sensing a temperature of the heating element;
wherein the temperature sensor is in thermal contact with the heating element and separated from the heating chamber.
